(19) United States
(12) Patent Application Publication
(10) Pub. No.: US 2015/0381305 A1
(43) Pub. Date: Dec. 31, 2015

(54) SELF-CALIBRATING TUNABLE LASER FOR OPTICAL NETWORK

(71) Applicant: Calix, Inc., Petaluma, CA (US)

(72) Inventors: Harold A. Roberts, Prior Lake, MN (US); Christopher T. Smith, Tulsa, OK (US)

(21) Appl. No.: 14/749,262

(22) Filed: Jun. 24, 2015

Related U.S. Application Data
(60) Provisional application No. 62/018,467, filed on Jun. 27, 2014.

(51) Int. Cl. H04J 14/02; H04B 10/079; H04Q 11/00; H04B 10/071

(52) U.S. Cl. CPC H04J 14/0221; H04B 10/071; H04B 10/07955; H04Q 11/0067; H04Q 11/0005; H04J 14/0239; H04Q 2011/0083; H04Q 2011/0009

(57) ABSTRACT

Techniques are described for adjusting the wavelength of a laser so that the laser transmits at the defined wavelength without needing feedback from an optical line terminal (OLT) and without needing tap filters that follows a tunable filter in the upstream transmission path.

This application claims the benefit of U.S. Provisional Application No. 62/018,467, filed Jun. 27, 2014, which is hereby incorporated by reference in its entirety.

### TECHNICAL FIELD

This disclosure relates to networking, and more particularly, communication between an optical network interface device and an optical line terminal (OLT) in an optical network.

### BACKGROUND

Network interface devices permit a subscriber to access a variety of information via a network. A passive optical network (PON), for example, can deliver voice, video and data among multiple network nodes, using a common optical fiber link. Passive optical splitters and combiners enable multiple network interface devices such as optical network terminals (ONTs), also referred to as optical network units (ONUs), to share the optical fiber link. Each network interface device terminates the optical fiber link for a residential or business subscriber, and is sometimes referred to as a subscriber premises node that delivers Fiber to the Premises (FTTP) services.

In some systems, a network interface device is connected with wiring to one or more subscriber devices in the subscriber premises, such as televisions, set-top boxes, telephones, computers, or network appliances, which ultimately receive the voice, video and data delivered via the PON. In this manner, the network interface device can support delivery of telephone, television and Internet services to subscriber devices in the subscriber premises.

### SUMMARY

In general, this disclosure describes example techniques for tuning a tunable laser of a network interface device to output optical signals at a defined wavelength. A transceiver of the network interface device includes a filter that passes through optical signals transmitted by the laser within the transceiver of the network interface device at the defined wavelength, and reflects optical signals transmitted at other wavelengths. A controller of the network interface device determines information indicative of an amount of optical power that is reflected by the filter. The controller adjusts the wavelength at which the laser outputs optical signals to minimize the amount of optical power reflected by the filter. The wavelength at which the amount of optical power reflected by the filter is, at a minimum, equal to the defined wavelength because at this wavelength the filter is allowing almost all of the optical signal to pass through, and reflecting a very small, if any, optical signal.

In one example, the disclosure describes a method comprising causing a laser to transmit an optical signal at a first wavelength through a filter, determining an amount of optical power of the optical signal reflected by the filter, and adjusting wavelength at which the laser transmits the optical signal from the first wavelength to a second wavelength at which the amount of optical power reflected by the filter is approximately minimized.

In one example, the disclosure describes a network interface device comprising a laser, a filter, and a controller. The controller is configured to cause the laser to transmit an optical signal at a first wavelength through the filter, determine an amount of optical power of the optical signal reflected by the filter, and adjust a wavelength at which the laser transmits the optical signal from the first wavelength to a second wavelength at which the amount of optical power reflected by the filter is approximately minimized.

In one example, the disclosure describes a network interface device comprising means for causing a laser to transmit an optical signal at a first wavelength through a filter, means for determining an amount of optical power of the optical signal reflected by the filter, and means for adjusting wavelength at which the laser transmits the optical signal from the first wavelength to a second wavelength at which the amount of optical power reflected by the filter is approximately minimized.

In one example, the disclosure describes a computer-readable storage medium having instructions stored thereon that when executed cause one or more processors to cause a laser to transmit an optical signal at a first wavelength through a filter, determine an amount of optical power of the optical signal reflected by the filter, and adjust a wavelength at which the laser transmits the optical signal from the first wavelength to a second wavelength at which the amount of optical power reflected by the filter is approximately minimized.

In one example, the disclosure describes a system comprising an optical line terminal (OLT) and a network interface device. The network interface device comprises a laser, a filter, and a controller. The controller is configured to cause the laser to transmit an optical signal at a first wavelength through the filter to the OLT, determine an amount of optical power of the optical signal reflected by the filter, and adjust a wavelength at which the laser transmits the optical signal from the first wavelength to a second wavelength at which the amount of optical power reflected by the filter is approximately minimized without receiving feedback from the OLT.

The details of one or more aspects of the disclosure are set forth in the accompanying drawings and the description below. Other features, objects, and advantages of the disclosure will be apparent from the description and drawings, and from the claims.

### BRIEF DESCRIPTION OF DRAWINGS

FIGS. 1A and 1B are histogram diagrams illustrating a number of lasers that provide different levels of side mode suppression ratio (SMSR).

FIG. 2 is a block diagram illustrating an optical network, in accordance with one or more aspects of this disclosure.

FIG. 3 is a block diagram illustrating an example of a network interface device in accordance with the techniques described in this disclosure.

FIG. 4 is a block diagram illustrating an example of a transceiver module of a network interface device.

FIG. 5A is a functional illustrating an example of a commercial receive optical sub-assembly (ROSA).

FIG. 5B is a conceptual diagram illustrating filtering performed by a tunable filter included in the ROSA of FIG. 5A.

FIG. 6 is a block diagram illustrating another example of a transceiver module of a network interface device.

FIG. 7 is a conceptual diagram illustrating passbands of a tunable filter.

FIG. 8 is a block diagram illustrating another example of a transceiver module of a network interface device.

FIG. 9 is a block diagram illustrating another example of a transceiver module of a network interface device.

FIG. 10 is a flowchart illustrating an example method of operation in accordance with techniques described in this disclosure.

### DETAILED DESCRIPTION

An optical network includes an optical line terminal (OLT), an optical splitter/combiner, and a plurality of network interface devices such as optical network units (ONUs), also referred to as optical network terminals (ONTs). The OLT connects to the optical splitter/combiner with a fiber link, and each one of the network interface devices connect to the optical splitter/combiner with respective fiber links. In other words, there is a fiber link from OLT to optical splitter/combiner, and a plurality of fiber links (a fiber link for each network interface device) from the optical splitter/combiner to the network interface devices.

For downstream transmission, the OLT outputs an optical signal to the optical splitter/combiner, and the optical splitter/combiner transmits the optical signal to each network interface device via respective fiber links. Each of the network interface devices determines whether the received optical signal is addressed to it or to another network interface device. Each network interface device processes the optical signal when the optical signal is addressed to it.

For upstream transmission, each network interface device transmits a respective optical signal to the optical splitter/combiner, and the optical splitter/combiner combines the optical signal with other optical signals for transmission to the OLT. Each network interface device may reside at a subscriber premises, or a plurality of subscriber premises may share a common network interface device. Each network interface device receives data from devices at one or more subscriber premises, converts the received data into the optical signal, and outputs the optical signal to the OLT via respective fiber links and the optical splitter/combiner.

To avoid collision of the optical signals from respective network interface devices, each network interface device may transmit the optical signal within an assigned timeslot. For example, the OLT may assign each of the network interface devices a timeslot within which to transmit the optical signal, and each network interface device transmits its optical signal within the begin and end time of the assigned timeslot. The assigned timeslot is reserved for an upstream transmission from given network interface device.

In the techniques described in this disclosure, the OLT and each of the network interface devices are configured to operate in a multiple wavelength system. An example of a multiple wavelength system is the ITU-T G.989 (NG-PON2) standard. The ITU-T G.989 standard is described in Recommendation ITU-T G.989.1, Series G: Transmission Systems and Media, Digital Systems and Networks, Digital sections and digital line system—Optical line systems for local and access networks, “40-Gigabit-capable passive optical networks (NG-PON2): General requirements, 03/2013. In a multiple wavelength system, there may exist a plurality of OLT ports (e.g., at different geographical locations, different OLT cards within the same chassis, or other configurations with multiple OLTs). In some examples of the multiple wavelength system, there may be one OLT that is configured to transmit and receive optical signals via multiple different wavelengths. For ease of illustration, the examples are described with respect to there being multiple OLTs in a multiple wavelength system.

In a multiple wavelength system, each OLT of a plurality of OLTs is associated with a group of all network interface devices and communicates (e.g., transmits and receives) only with the network interface devices within the associated group. For example, in the multiple wavelength system, a first OLT is associated with a first group of one or more network interface devices and communicates with the one or more network interface devices that belong to the first group. In the multiple wavelength system, a second OLT is associated with a second group of different one or more network interface devices and communicates with the one or more network interface devices that belong to the second group, and so forth. After initialization and assignment of network interface devices to OLTs, an OLT may not be able to transmit downstream optical signals to a network interface device to which it is not associated. In general, after initialization and assignment of network interface devices to OLTs, a network interface device should not transmit upstream optical signal to an OLT to which it is not associated.

To effectuate such communication, each OLT may be assigned different upstream/downstream wavelength pairs, and each set of network interface devices may be assigned different upstream/downstream wavelength pairs relative to the other sets of network interface devices. As an example, a first OLT may be configured to transmit downstream optical signals at a first downstream wavelength, and receive upstream optical signals at a first upstream wavelength. The first set of network interface devices, associated with the first OLT, may be configured to receive downstream optical signals at the first downstream wavelength, and transmit upstream optical signals at the first upstream wavelength. A second OLT may be configured to transmit downstream optical signals at a second downstream wavelength, and receive upstream optical signals at a second upstream wavelength. The second set of network interface devices, associated with the second OLT, may be configured to receive downstream optical signals at the second downstream wavelength, and transmit upstream optical signals at the second upstream wavelength, and so forth.

In this example, each of the wavelengths is different than the others. For instance, the first downstream wavelength is different than the second downstream wavelength, the first upstream wavelength, and the second upstream wavelength. The same is true for the second downstream wavelength, the first upstream wavelength, and the second upstream wavelength.

In some examples, the difference in the wavelengths between the first downstream wavelength for the network interface devices in the first group and the second downstream wavelength for the network interface device in the second group may be relatively small (e.g., in the order of less than a nanometer). Accordingly, the lasers may be required to produce very little optical power at wavelengths other than the defined wavelength.

For example, although a predominant amount of the optical power outputted by the laser may be at the defined wavelength, there may be some optical power at wavelengths proximate to the defined wavelength (e.g., ±1-10 nm). The wavelength where the optical power of the optical signal is the greatest is referred to as a main mode, and the wavelengths where there is some amount of optical power are referred to as side modes. In some multiple wavelength systems, there may be a requirement of approximately 55 dB difference between the main mode and the side mode. In other words, there may be a requirement that the side mode suppression ratio (SMSR) for a multiple wavelength system be approximately 55 dB.

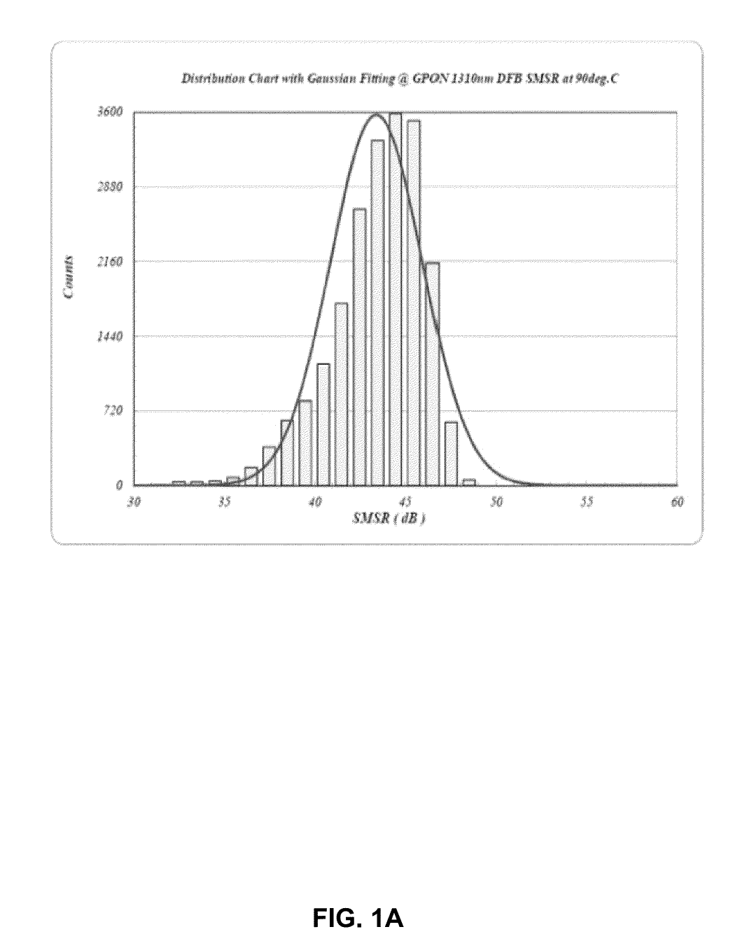

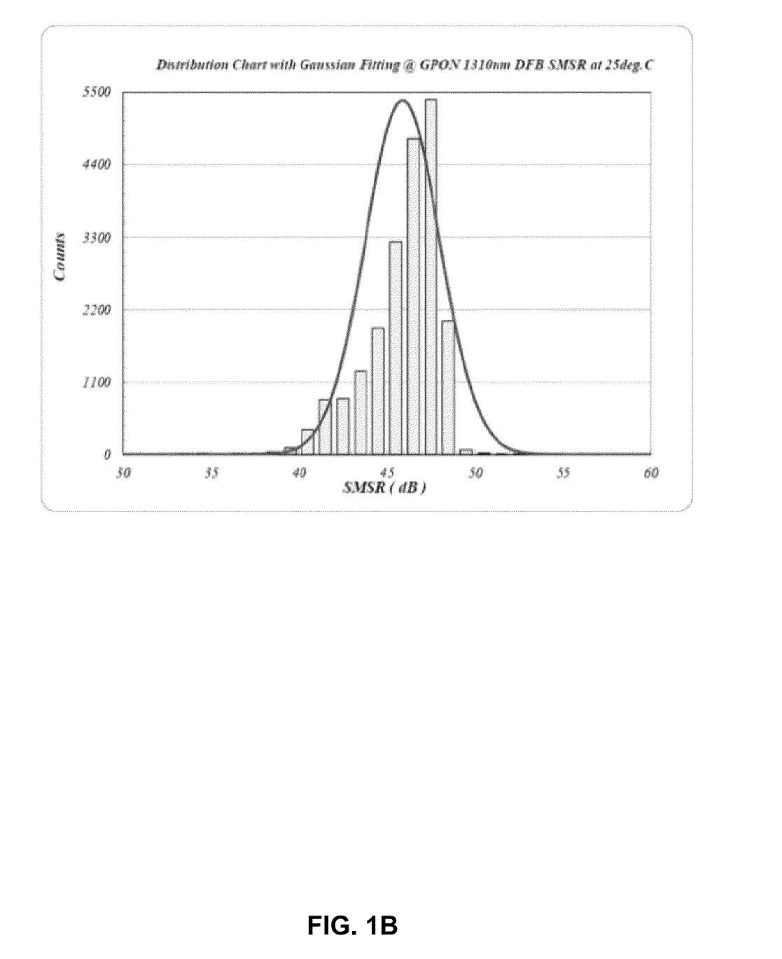

However, very few lasers provide a SMSR of 55 dB, and potentially no laser provides a SMSR of 55 dB at higher temperatures. For example, FIGS. 1A and 1B are histogram diagrams illustrating the number of lasers that provide different levels of suppression ratio (SMSR). In FIGS. 1A and 1B, the wavelength of the lasers is set to 1310 nano-meter (nm). FIG. 1A illustrates the histogram with an ambient temperature of 90 degrees Celsius, and FIG. 1B illustrates the histogram with an ambient temperature of 25 degrees Celsius. In other words, FIGS. 1A and 1B are generated by testing the SMSR of various lasers at different temperatures and recording the number of lasers that provide a particular amount of the SMSR.

As can be seen in FIGS. 1A and 1B, many lasers provide a SMSR of at least 47 dB. However, there are very few lasers that provide SMSR of 55 dB at 25 degrees Celsius. There may be no lasers capable of providing SMSR of 55 dB at 90 degrees Celsius.

To address the issue, techniques were proposed for using a variable optical attenuator, using a tunable tracking laser filter, and designing a low SMSR chip. The inclusion of a variable optical attenuator reduces the overall power of the optical signal, and therefore may not function as a viable solution. Also, designing a low SMSR chip may be overly complicated and difficult to design.

In the techniques described in this disclosure, a transceiver module of each network interface device includes a tunable laser filter. This way the laser filter only passes through optical signals at the defined wavelength and does not pass through optical signals at other wavelengths, which allows for an SMSR of at least 55 dB. The reason the laser filter is tunable is because the wavelength at which a network interface device transmits the optical signal is based on the group to which it belongs. For example, network interface devices of the first group transmit optical signals at a first upstream wavelength, and network interface devices of the second group transmit optical signals at a second upstream wavelength. Therefore, a filter in each of the network interface devices of the first group would be tuned to pass through the optical signals of the first upstream wavelength, and a filter in each of the network interface devices of the second group would be tuned to pass through the optical signals of the second upstream wavelength.

Moreover, because the wavelength at which each of the network interface devices transmits optical signals is based on the group to which the network interface devices belong, the transceiver module of each network interface device includes a tunable laser whose wavelength can be adjusted (e.g., tuned) so that the laser outputs optical signals at the defined wavelength. For example, a laser in each of the network interface devices of the first group would be tuned to transmit optical signals at the first downstream wavelength, and a laser in each of the network interface devices of the second group would be tuned to transmit optical signals at the second downstream wavelength.

However, it may not be readily determinable whether the laser is transmitting the optical signal at the defined wavelength. For instance, the laser may need to be tuned to transmit at the first downstream wavelength, but may be transmitting at a slightly different wavelength. As an example, the tunable filter may be tuned to a wavelength of 1310 nm to filter out all other wavelengths to achieve 55 dB SMSR. However, it may be unknown whether the laser is actually transmitting at a wavelength of 1310 nm or at a slightly different wavelength. In other words, the filter may be set to the defined wavelength, but it is still unknown whether the laser is set to transmit at the defined wavelength.

In some techniques, the network interface device and the OLT may be functioning together to determine whether the laser of the network interface device is transmitting at the defined wavelength. For example, the network interface device may transmit an optical signal at the wavelength to which the laser is tuned. The OLT may respond back to the network interface device indicating whether the OLT received the optical signal. If the OLT indicates that the optical signal was not received, the network interface device would adjust the wavelength of the laser, and the process repeats until the OLT indicates that an optical signal with sufficient optical power was received (and may keep adjusting until maximum power is received so that the wavelength is centered in the channel), and the network interface device stops adjusting the wavelength of the optical signal that the laser transmits. However, such techniques of transmitting an optical signal to the OLT and waiting for confirmation from the OLT that the optical signal was received to ensure that the laser is tuned to the defined wavelength may require an undesirable amount of time and the laser may transmit in the wrong channel initially (e.g., at the wrong wavelength) and interfere with the transmission of other PONs.

The techniques described in this disclosure provide for a mechanism by which the network interface device can itself determine whether its laser is tuned to transmit at the defined wavelength and adjust the wavelength at which the laser transmits (e.g., tune the laser) so that the laser transmits optical signals at the defined wavelength. For instance, the techniques described in this disclosure potentially do not require feedback from the OLT indicating whether the laser is transmitting at the defined wavelength. In this sense, the techniques described in this disclosure may be considered as techniques for self-calibrating a tunable laser.

As one example, the tunable filter is positioned in front of the C/L band splitter (i.e., the splitter that separates upstream and downstream optical signals) and is used to filter both the upstream and downstream wavelengths simultaneously (e.g., in harmonically locked passbands, described in more detail with respect to FIG. 7). The transceiver module of the network interface device may also include a tap filter on the upstream output of the tunable filter. This tap filter may reflect a portion of the optical signal at the output of the tunable filter to a photo-diode. The photo-diode converts the optical signal to a current, and a controller of the network interface device may determine how much optical power is being outputted by the tunable filter based on the amplitude of the current from the photo-diode. For instance, if the controller determines that the amplitude of the current is relatively low, the controller may determine that little optical signal is passing through the tunable filter. If the controller determines that the amplitude of the current is relatively high, the controller may determine that most of the optical signal is passing through the tunable filter.

The controller may then adjust the wavelength at which the laser outputs the optical signal such that the amplitude of the current from the photo-diode is approximately maximized (e.g., to produce a maximum value minus a threshold such as 0 to 10% merely as one example). This would mean that most of the optical signal is passing through the tunable filter (e.g., the filter is harmonically locked for the transmit and receive passbands), which in turn means that the laser is outputting at the defined wavelength. This is because the tunable filter only passes through optical signals at the defined wavelength, and therefore, if the current through the photo-diode is at its maximum, it means that the laser is outputting at the defined wavelength.

There may be issues with the above example technique of using a tap filter at the output of the tunable filter for adjusting the wavelength at which the laser outputs the optical signal to the defined wavelength. For example, placing a tap filter component in the transmission path of the laser poses multiple challenges. In particular, the tap filter can increase packaging size, cost, and introduce additional optical loss. The transmit path in the ‘miniature optical bench’ that is the BOSA (Bidirectional Optical Sub-Assembly) must have precision optics to effectively couple laser light to the fiber. Unlike the receive path, the transmit path requires very tight mechanical tolerances to achieve efficient laser/fiber coupling. Therefore, it may be preferable to have as few components as possible in the transmit path and to keep the transmit path short. The tap filter requires additional separation between the laser and the fiber and may result in more optical loss due to separation. Moreover, the tap itself will introduce loss (by definition) since it is ‘stealing’ a portion of the light for the purpose of monitoring.

The techniques described in this disclosure are related to tuning a laser of a network interface device based on an amount of optical signal that a filter coupled to the laser reflects. In this way, the techniques do not determine information indicative of an amount of optical power of the optical signal that passes through the filter. Rather, the techniques determine information indicative of an amount of optical power of the optical signal that the filter did not pass through.

For example, as described above, the laser of a network interface device outputs the optical signal via a filter (e.g., a tunable filter) to reduce the optical power from the side modes. In the techniques described in this disclosure, the filter reflects the optical signal that does not pass through the filter. A photo-diode receives the reflected optical signal and converts the optical signal into a current. In this case, the amplitude of the current from the photo-diode indicates an amount of optical power that did not pass through the filter. A controller of the network interface device may determine an amount of optical power that is not passing through the filter based on the amplitude of the current from the photodiode.

For instance, if the controller determines that the amplitude of the current is relatively high, the controller may determine that little optical signal is passing through the tunable filter because most of the optical signal is being reflected by the tunable filter. If the controller determines that the amplitude of the current is relatively low, the controller may determine that most of the optical signal is passing through the tunable filter because little of the optical signal is being reflected by the tunable filter.

As described in more detail below, the tunable filter includes two passbands: one passband to allow transmission of upstream optical signals from the network interface devices, and another passband to allow reception of downstream optical signals. In some examples, the two passbands are harmonically locked such that if one of the passbands is adjusted, the other adjusts by the same amount.

The controller may adjust the wavelength at which the laser outputs the optical signal such that the amplitude of the current from the photo-diode is minimized. This would mean that most of the optical signal is passing through the tunable filter, which in turn means that the laser is outputting at the defined wavelength. This is because the tunable filter only passes through optical signals at the defined wavelength, and therefore, if the electrical current through the photo-diode is at its minimum, it means that the laser is outputting at the defined wavelength because most of the optical signal is passing through and very little is being reflected.

Tuning the laser (e.g., adjusting the wavelength of the laser) such that the laser outputs optical signals at the defined wavelength based on a reflected optical signal may overcome some of the issues described above with respect to the example where laser tuning is based on the amount of optical power of the optical signal that passes through the filter. For example, in the reflection based technique, the fiber can be coupled directly to the filter because the photo-diode is not on the output of the filter, and no tap filter is needed. Therefore, the transmit path can be made relatively short and there is no “stealing” of optical power from the transmit path.

There are various ways in which to determine the amount of the optical power of the reflected optical signal. As one example, it is possible to tilt the position of tunable filter within the transceiver module. Tilting the filter a small amount may not affect its transmittance, and therefore, if the wavelength of the optical signal is at the defined wavelength, then the optical signal passes through the filter no differently than if there was no tilt in the filter. However, the tilt in the filter changes the angle at which the optical signal reflects (i.e., two times the angle of incidence). Therefore, if the wavelength of the optical signal is not at the defined wavelength, then the optical signal reflects at two times the angle of incidence of the filter. In this example, a photo-diode may be positioned at an angle two times the angle of incidence of the filter so that the photo-diode receives the reflected optical signal.

As another example, rather than using an additional photo-diode, the techniques may leverage the back-facet photo-diode that is built into the package that holds the laser. This back-facet photo-diode is built into the package that holds the laser to provide feedback current indicative of the amplitude of the laser for various purposes such as automatic power control (APC). It may be possible for this back-facet photo-diode to receive the optical signal reflected by the tunable filter. In this example, it may not be necessary to tilt the filter, although it may be desirable for the filter to be slightly tilted to avoid negative feedback effects in the laser cavity and still use the back-facet photodiode for tuning the laser.

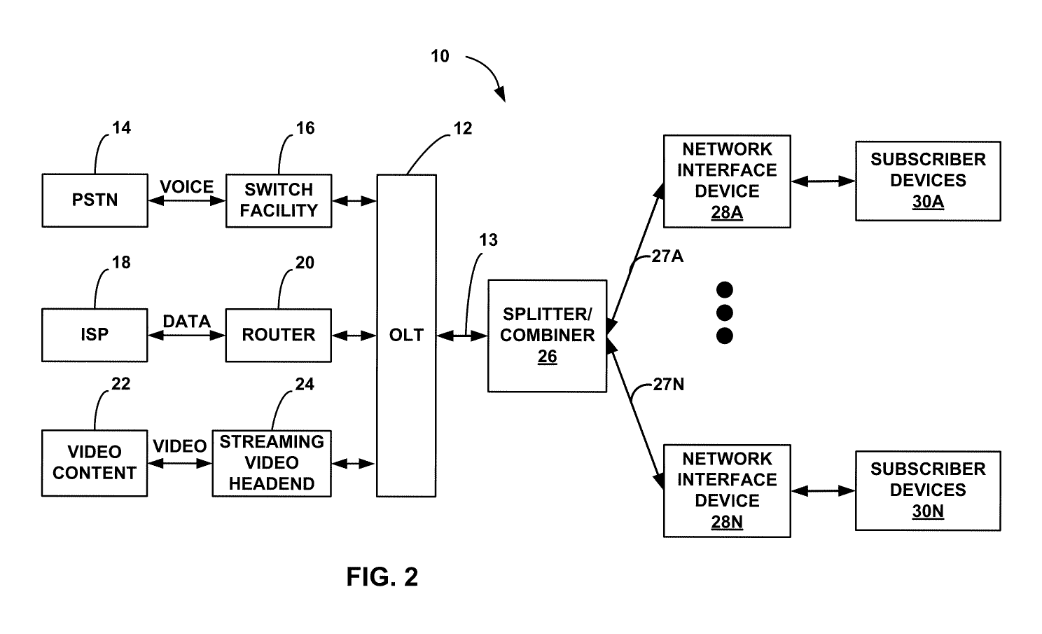

FIG. 2 is a block diagram illustrating a network 10. For purposes of illustration, the example implementations described in this disclosure are described in context of an optical network (e.g., a passive optical network (PON)) such as next generation PON2 (NG-PON2). Accordingly, network 10 may be referred to as PON 10. However, aspects of this disclosure are not so limited, and can be extended to other types of networks such as cable or digital subscriber line (DSL) based networks, or Active Ethernet which may be considered as optical transmission and reception in accordance with the Ethernet protocol. Active Ethernet is defined by the IEEE 802.3ah standard (e.g., in clause 59 of the 802.3ah standard). Examples of network 10 also include shared-medium transports such as WiFi and RF/DOCSIS.

As shown in FIG. 2, PON 10 may deliver voice, data and video content (generally “information”) to a number of network nodes via optical fiber links In some examples, PON 10 may be arranged to deliver Internet Protocol television (IPTV) and other high speed information (e.g., information transmitted at approximately 200 Mbps or higher). PON 10 may conform to any of a variety of PON standards, such as the broadband PON (BPON) standard (ITU G.983), Ethernet PON (EPON), the gigabit-capable PON (GPON) standard (ITU G.984), or 10 giga-bit NGPON (ITU G.989), NG-PON2, as well as future PON standards under development by the Full Service Access Network (FSAN) Group, such as 10G GPON (ITU G.987), or other organizations.

Optical line terminal (OLT) 12 may receive voice information, for example, from the public switched telephone network (PSTN) 14 via a switch facility 16. In addition, OLT 12 may be coupled to one or more Internet service providers (ISPs) 18 via the Internet and a router 20. As further shown in FIG. 2, OLT 12 may receive video content 22 from video content suppliers via a streaming video headend 24. Video also may be provided as packet video over the Internet. In each case, OLT 12 receives the information, and distributes it along optical fiber link 13 to optical splitter/combiner 26.

Optical splitter/combiner 26 then distributes the information to network interface devices 28A-28N (collectively referred to as “network interface devices 28”) via respective fiber optic links 27A-27N (collectively referred to as “fiber optic links 27”). In some examples, PON 10 includes 128 network interface devices 28; however, the aspects of this disclosure are not so limited. Also, network interface devices 28 may be referred to as optical network units (ONUs) or optical network terminals (ONTs).

A single network interface device 28 is an example of a network interface device. Other examples of a network interface device include, but are not limited to, a cable modem or a DSL modem. However, for purposes of illustration but without limitation, the example implementations described in the disclosure are described in the context of the network interface device being an ONU or ONT.

Each one of network interface devices 28 may reside at or near a subscriber premises that includes one or more subscriber devices 30A-30N (collectively referred to as “subscriber devices 30”). For instance, network interface device 28A resides at or near a subscriber premises that includes one or more subscriber devices 30A, and network interface device 28N resides at or near a subscriber premises that includes one or more subscriber devices 30N. The subscriber premises may be a home, a business, a school, or the like. A single network interface device 28 may be capable of transmitting information to and receiving information from one or more subscriber premises.

As illustrated, a single network interface device 28 may directly transmit information to or receive information from one or more subscriber devices 30 within the subscriber premises. Examples of the subscriber devices 30 include, but are not limited to, one or more computers (e.g., laptop and desktop computers), network appliances, televisions, game consoles, set-top boxes, wireless devices, media players or the like, for video and data services, and one or more telephones for voice services. Subscriber devices 30 may also include household appliances such as furnaces, washer and dryers, freezers, refrigerators, thermostats, lights, security systems, and the like.

OLT 12 transmits downstream information to and receives upstream information from network interface devices 28 via fiber link 13 coupled to splitter/combiner 26. Downstream information may be considered to be information transmitted by OLT 12 and received by network interface devices 28. Upstream information may be considered to be information transmitted by each one of network interface devices 28 and received by OLT 12. As illustrated in FIG. 2, optical splitter/combiner 26 may be coupled to each one of network interface devices 28 via respective optical fiber links 27.

In some examples, optical splitter/combiner 26 may be a passive splitter/combiner. A passive splitter/combiner may not need to be powered. For downstream transmission, including voice, video, and data information from OLT 12, optical splitter/combiner 26 receives the downstream information and splits the downstream information for downstream transmission to network interface devices 28 via respective fiber links 27. For upstream information, including voice and data information from each one of network interface devices 28, optical splitter/combiner 26 receives upstream information from network interface devices 28 via respective fiber links 27 and combines the upstream information for transmission to OLT 12.

In some examples, optical splitter/combiner 26 may not be a passive splitter/combiner, but rather an active splitter/combiner. In these examples, optical splitter/combiner 26 may be powered locally. In these examples, optical splitter/combiner 26 may function as an optical switch, router, multiplexer, or the like.

Network interface devices 28 receive and transmit information via respective fiber links 27. Also, OLT 12 receives and transmits information via fiber link 13. To differentiate between transmission and reception, each one of network interface devices 28 may be configured to transmit voice and data information with an optical signal with a wavelength of 1310 nanometer (nm), receive voice and data information with an optical signal with a wavelength of 1490 nm, and receive video information with an optical signal with a wavelength of 1550 nm. OLT 12 may be configured to receive voice and data information with an optical signal with a wavelength of 1310 nm, transmit voice and data information with an optical signal with a wavelength of 1490 nm, and transmit video information with an optical signal with a wavelength of 1550 nm. These wavelengths are provided merely as examples.

In some examples, PON 10 may be a multiple wavelength system, such as in NG-PON2. In such a system, the upstream and downstream wavelengths are tunable. For example, the upstream wavelength may be tunable over a range of 400 giga-hertz (GHz) to 800 GHz, where the conversion from frequency to wavelength is given by the equation speed of light divided by wavelength equals frequency.

The specific transmit and receive wavelengths indicated above are provided for illustration purposes only. In different examples, network interface devices 28 and OLT 12 may be configured to transmit and receive information with optical signals at different wavelengths than those provided above. However, the transmission and reception wavelengths of the optical signals should be different.

Each one of network interface devices 28 may be configured to transmit upstream information according to time division multiple access (TDMA) techniques. For instance, OLT 12 may grant or assign to each of subscriber devices 30 certain timeslots during which to transmit upstream information. Each one of network interface devices 28 transmits information to OLT 12 based on the timeslots assigned to each of respective subscriber devices 30. The timeslot for each one network interface devices 28 may be different. In this manner, each one of network interface devices 28 may transmit information without collision of information from two or more different network interface devices 28 at splitter/combiner 26. Collision of information may occur if splitter/combiner 26 receives upstream information from two or more network interface devices 28 at the same wavelength at the same time.

As one example of the TDMA techniques, when one of network interface devices 28 (e.g., network interface device 28A), is powered on for the first time, OLT 12 may perform an auto-ranging process, as is well known in the art. For instance, during the auto-ranging process, OLT 12 may calculate the total propagation delay (e.g., the total time it takes to transmit information to network interface device 28A and receive information from network interface device 28A). OLT 12 may perform a similar auto-ranging process on each one of network interface devices 28.

After the auto-ranging process, OLT 12 may calculate an equalization delay for each one of network interface devices 28, utilizing techniques well known in the art. The equalization delay equalizes the propagation delay of each one of network interface devices 28, relative to the other network interface devices 28. OLT 12 may transmit the equalization delay to each one of network interface devices 28 utilizing a physical layer operations and maintenance (PLOAM) message or utilizing an ONU management control interface (OMCI) message.

Once all the equalization delays are calculated and transmitted to network interface devices 28, OLT 12 may grant the timeslots during which each one of network interface devices 28 should transmit data (e.g., an optical signal). OLT 12 may transmit a bandwidth map to each one of network interface devices 28 indicating the timeslots during which each one network interface devices 28 should transmit data. OLT 12 may transmit the bandwidth map utilizing a PLOAM or OMCI message, or other message. In this way, PON 10 utilizes time division multiplexing to precisely synchronize transmission from all ONTs (e.g., network interface devices 28) such that each ONT transmits during a window where all other ONTs are quiet.

There may be certain constraints on network interface devices 28 to function properly in a NG-PON2 system. As mentioned above, one requirement may be that the tunability of the wavelength of the optical signal that network interface devices 28 output be over a 400 GHz to 800 GHz range. In addition, network interface devices 28 should provide very low SMSR (side mode suppression ratio), referred to as OOC (Out of Channel) noise in G.989.2. There should be short term spectral excursion (STSE), which is a unique issue of burst mode for dense wavelength division multiplexing (DWDM). Also, there should very accurate tuning (e.g., approximately 10 GHz) to stay within the MTSE (Maximum Tuned Spectral Excursion).

Each one of network interface devices 28 includes a transceiver module. This disclosure describes examples of transceiver modules that are configured such that network interface devices 28 conform to the above requirements for NG-PON2. The example transceiver modules may conform to the requirements of other optical transport standards as well, but the disclosure is described with respect to NG-PON2 to assist with understanding.

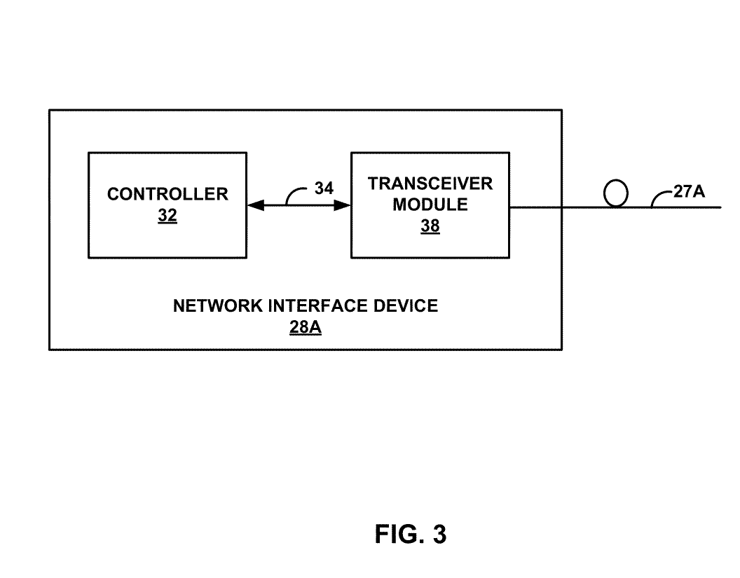

FIG. 3 is a block diagram illustrating an example of a network interface device in accordance with the techniques described in this disclosure. For purposes of illustration, FIG. 3 illustrates network interface device 28A in greater detail. Network interface devices 28B-28N may be substantially similar to network interface device 28A.

As illustrated, network interface device 28A includes controller 32 and transceiver module 38 for upstream transmission and downstream reception. For example, transceiver module 38 converts the electrical signal that controller 32 outputs, via data line 34, into an optical signal for transmission via fiber link 27A, and converts the optical signal received from fiber link 27A into an electrical signal, and transmits the electrical signal to controller 32 via data line 34.

In this disclosure, data line 34 is illustrated as a single line for ease of illustration. Data line 34 may be the interface between controller 32 and transceiver module 38 that allows controller 32 and transceiver module 38 to transmit data to one another. Therefore, data line 34 may include a plurality of lines, where some of the lines are high speed transmission lines for high speed data transmission, and some of the lines are low speed transmission lines for transmission of control signals.

Also, there may be additional components interspersed between transceiver module 38 and controller 32 such as a trans-impedance amplifier (TIA) that converts downstream current signals into voltage signals, a limiting amplifier that limits the voltage signals outputted by the TIA, and a clock-and-data recovery (CDR) circuit for removing jitter in the voltage signal. Controller 32 receives the output of the CDR. For upstream, controller 32 may output the voltage signal to a laser driver, and the laser driver controls the amount of current that flows through the laser to convert the electrical signal into an optical signal.

For upstream transmission, transceiver module 38 includes a tunable laser whose wavelength can be adjusted to transmit optical power at a defined wavelength. For instance, during initialization, OLT 12 may define the upstream wavelength and the downstream wavelength for network interface devices 28. There may be other ways in which to define the upstream and downstream wavelengths (e.g., by pre-configuration). Controller 32 may tune the laser of transceiver module 38 so that the laser of transceiver module 38 outputs optical signals at the defined wavelength. Transceiver module 38 includes other components described in more detail below.

For example, a tunable filter within transceiver module 38 may be configured to pass through only optical signals that are transmitted at the defined wavelength, and may reflect back optical signals that are not transmitted at the defined wavelength. A photo-diode within transceiver module 38 may receive the reflected optical signal, and convert the optical signal into an electrical current. Controller 32 may determine an amount of optical power that is reflected based on the electrical current outputted by the photo-diode. Controller 32 may adjust the wavelength of the laser to minimize the amount of optical power that is reflected back, which controller 32 can determine based on the electrical current outputted by the photo-diode. Minimizing the amount of optical power that is reflected results in the laser being tuned to transmit optical signals at the defined wavelength.

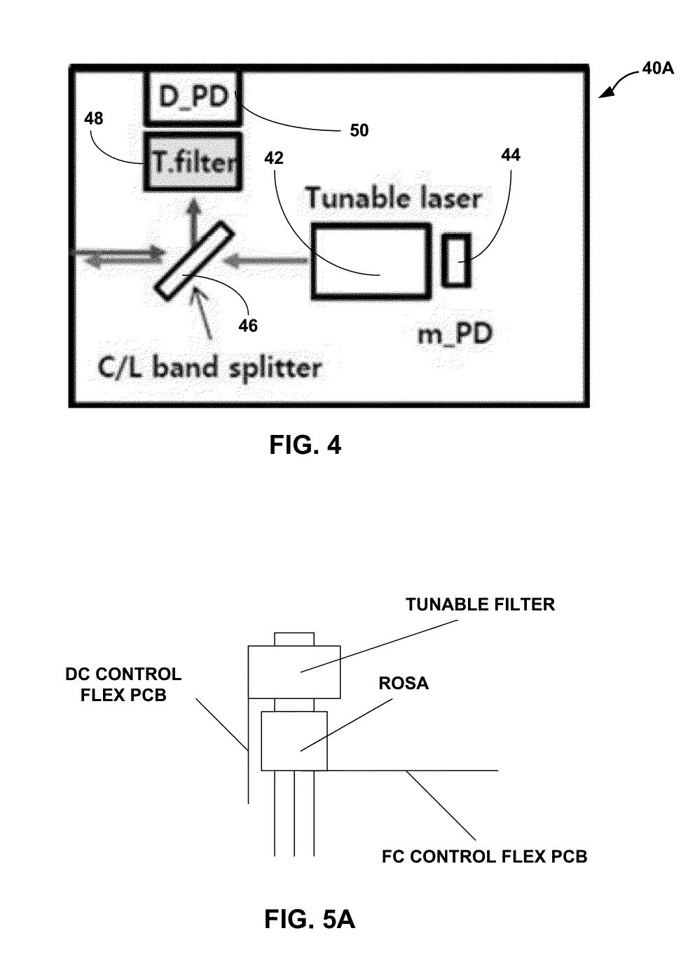

FIG. 4 is a block diagram illustrating an example of a transceiver module of a network interface device. As illustrated, in FIG. 4, transceiver module 40A, which is one example of transceiver module 38 of FIG. 3, includes a tunable laser 42 with a monitor photo-diode (m_PD) 44, a C/L band splitter 46, a tunable filter (T. filter) 48, and a downstream photo-diode (D_PD) 50.

C/L band splitter 46 receives downstream optical signals and reflects the downstream optical signal to tunable filter 48. Network interface devices 28 may be defined to receive downstream optical signals at a defined downstream wavelength, but may receive optical signals at other wavelengths as well. Accordingly, controller 32 may tune tunable filter 48 so that only optical signals with the defined downstream wavelength pass through the tunable filter to the downstream photo-diode (D_PD).

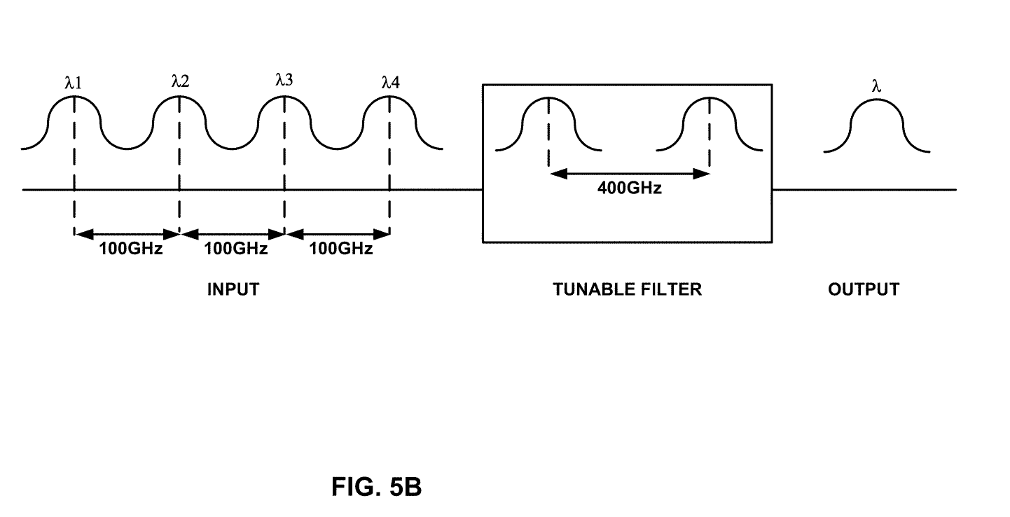

FIG. 5A is a block diagram illustrating an example of a commercial receive optical sub-assembly (ROSA). FIG. 5B is a conceptual diagram illustrating filtering performed by a tunable filter included in the ROSA of FIG. 5A. As illustrated in FIG. 5A, a tunable filter, an example of which is tunable filter 48, within the ROSA outputs optical signals to the photo-diode (e.g., D_PD in FIG. 4) within the ROSA. FIG. 5B illustrates the tunability of the tunable filter in the ROSA of FIG. 5A as being 400 GHz, allowing tuning to four channels separated by 100 GHz. When optical signals at different wavelengths are received by transceiver module 40A, only the optical signal with the wavelength defined for network interface devices 28 is passed through to the D_PD.

Referring back to FIG. 4, transceiver module 40A also includes tunable laser 42 that controller 32 tunes so that tunable laser 42 outputs optical signals at the defined wavelength. However, there may be some issues with transceiver module 40A that do not allow transceiver module 40A to conform to the requirements of NG-PON2. As one example, one of the requirements is to have very low SMSR (e.g., 55 dB reduction). As described above with respect to FIGS. 1A and 1B, there may be no laser that meets the SMSR requirements of cancelling side modes. In other words, transceiver module 40A may not meet requirements for OOC noise, STSE, or stay within MTSE without additional optical components or special laser design.

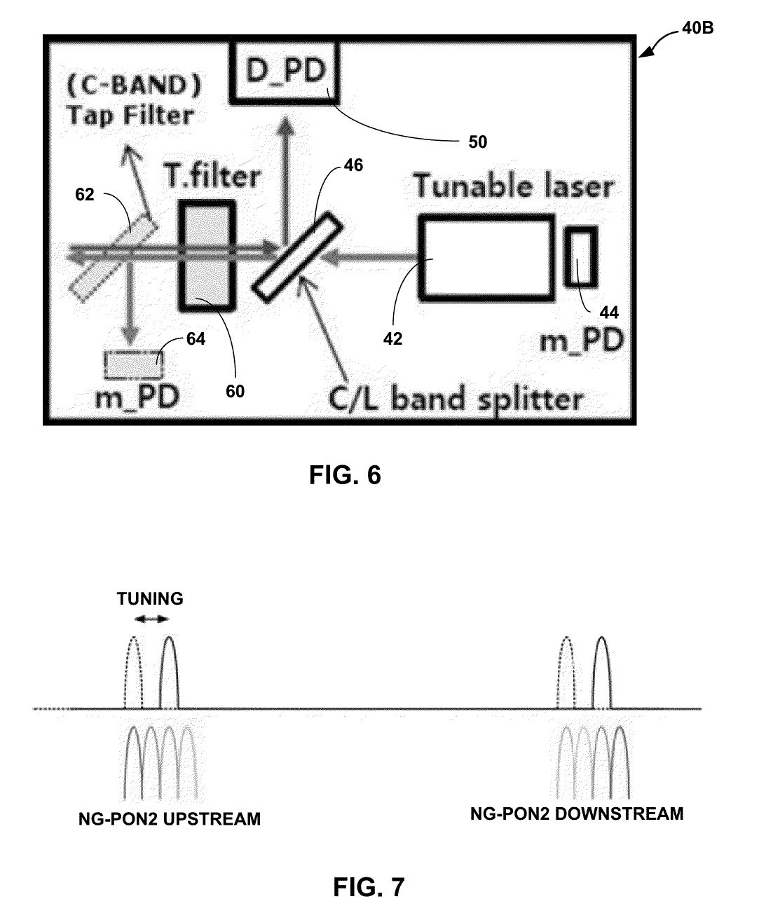

FIG. 6 is a block diagram illustrating another example of a transceiver module of a network interface device. FIG. 6 illustrates transceiver module 40B, which is another example of transceiver module 38 of FIG. 3. In FIG. 6, components with the same reference numerals as those in FIG. 4 are like components and are not described further.

Transceiver module 40B includes tunable filter 60 (T.filter) that is configured to perform “double duty.” For instance, by placing tunable filter 60 further upstream from C/L band splitter 46, tunable filter 60 only passes through optical signals with the defined downstream wavelength and only passes through optical signals with the defined upstream wavelength. For example, tunable filter 60 has two passbands separated by the frequency gap between the upstream and downstream wavelengths. The transmitter passband for tunable filter 60 is harmonically locked to the receiver passband for tunable filter 60. In other words, if the passband of tunable filter 60 for the downstream wavelength is adjusted, then the passband of tunable filter 60 for the upstream wavelength adjusts by the same amount.

FIG. 7 is a conceptual diagram illustrating passbands of the tunable filter. The left end of FIG. 7 illustrates the passband for the upstream wavelength of tunable filter 60 and the right end of FIG. 7 illustrates the passband for the downstream wavelength of tunable filter 60. As also illustrated, if the passband of tunable filter 60 for the upstream is adjusted, the passband of tunable filter 60 for the downstream adjusts by the same amount.

Referring back to FIG. 6, having tunable filter 60 perform double duty allows transceiver module 40B to conform to the requirements NG-PON2. However, there may be some additional issues. For instance, while controller 32 is tuning the tunable laser, there may not be a direct way for controller 32 to determine whether the laser is outputting optical signals at the defined wavelength. Instead, controller 32 may set the wavelength of the optical signal, and then wait for confirmation from OLT 12 as to whether the optical signal was received, and adjust the wavelength and repeat this process until controller 32 receives confirmation from OLT 12 that optical signal was received. Because tunable filter 60 only passes through optical signals with the defined wavelength, when controller 32 receives confirmation from OLT 12 that optical signal was received, controller 32 determines that the laser is outputting the optical signal at the defined wavelength. However, repeatedly waiting on confirmation from OLT 12 can be time consuming.

To allow controller 32 to determine whether the laser is outputting at the defined wavelength, transceiver module 40B includes tap filter 62 on the upstream output side of tunable filter 60. Tap filter 62 is illustrated as (C-BAND) Tap Filter. Tap filter 62 redirects a small portion of the laser light that passes through the transmit passband of tunable filter 60 to a second monitor photodiode (m_PD) 64 that is proposed as an addition to the classic back-facet monitor photodiode shown on the right side of the laser cavity (e.g., m_PD 44). This secondary m_PD 64 is used to provide a feedback signal that controller 32 uses to locally lock the laser of transceiver module 40B to the filter transmit passband. Therefore, controller 32 of network interface device 28A can lock the laser to the correct upstream wavelength without feedback control from OLT 12. For example, controller 32 may adjust the wavelength of tunable laser 42 until the current outputted by m_PD 64 is approximately maximized, because the wavelength of tunable laser 42 at which the current outputted by m_PD 64 is approximately maximized is the wavelength at which almost all of the optical signal outputted by laser 42 is passing through tunable filter 60.

However, there may be certain drawbacks to the example techniques illustrated in FIG. 6. For example, placing tap filter 62 in the transmission path of tunable laser 42 poses multiple challenges: it can increase packaging size, cost, and introduce additional optical loss. The transmit path in the ‘miniature optical bench’ that is the BOSA (Bidirectional Optical Sub-Assembly) may need precise optics to effectively couple laser light to the fiber. Unlike the receive path, the transmit path may require very tight mechanical tolerances to achieve efficient laser/fiber coupling. It is preferable to have as few components as possible in the transmit path and to keep the transmit path short. Tap filter 62 requires additional separation between tunable laser 42 and the fiber and may result in more optical loss due to separation. Moreover, tap filter 62 itself will introduce loss (by definition) since it is ‘stealing’ a portion of the light for the purpose of monitoring.

The techniques described in this disclosure provide examples of transceiver modules that allow network interface devices 28 to adjust the wavelength of the laser so that the laser is transmitting at the defined wavelength without needing feedback from OLT 12 and without needing a tap filter in the upstream transmit path. For example, the techniques rely on the reflection of the optical signals from a tunable filter to determine an amount of optical power of the optical signal that is not passing through and adjust the wavelength of the tunable laser to minimize the amount of optical power of the optical signal that is not passing through.

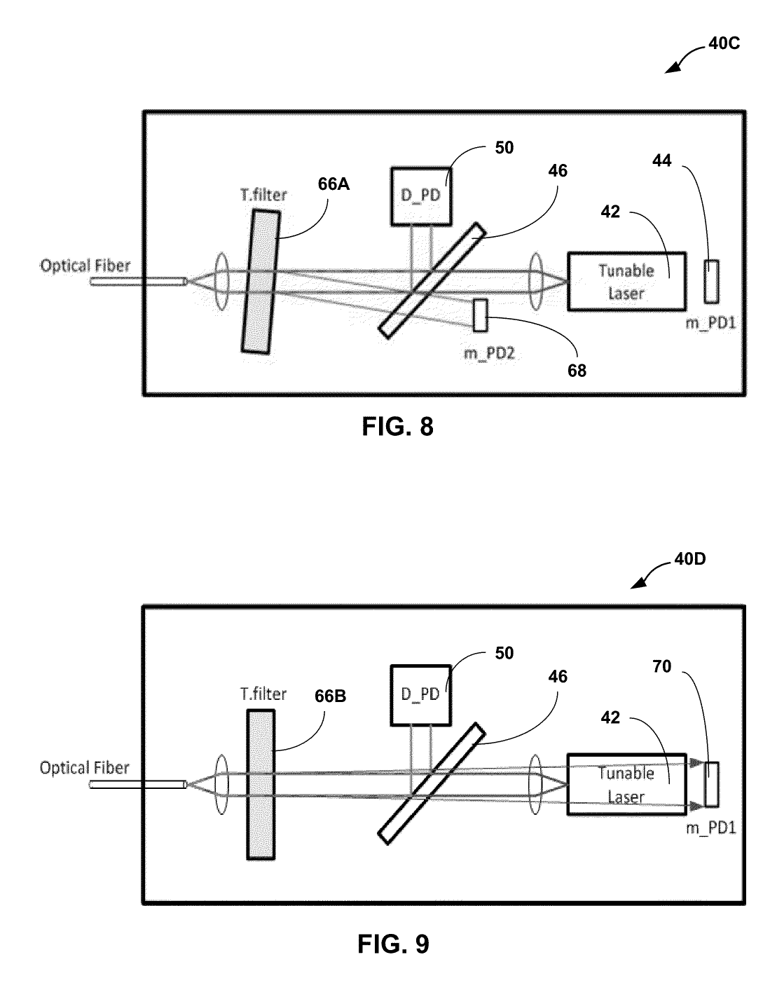

FIG. 8 is a block diagram illustrating another example of a transceiver module of a network interface device. FIG. 8 illustrates transceiver module 40C, which is another example of transceiver module 38 of FIG. 3. In FIG. 8, components with the same reference numerals as those in FIG. 4 or 6 are like components and are not described further.

As illustrated in FIG. 8, no tap filter in the upstream transmission is needed in transceiver module 40C. Rather, tunable filter 66A is tilted slightly to reflect optical signals to a second photo-diode (m_PD2) 68. For example, tunable filter 66A may reflect back upstream optical signals that are transmitted at wavelengths other than the defined wavelength, and m_PD2 68 may receive the resulting optical signal via tunable filter 66A and splitter 46. Photo-diode m_PD2 68 may generate a current whose amplitude is based on the amount of optical power of the reflected optical signal. This current may function as a feedback that controller 32 uses to adjust the wavelength of tunable laser 42. For instance, controller 32 may adjust the wavelength of laser 42 so as to minimize the amount of current that photodiode m_PD2 68 outputs. In other words, instead of maximizing the transmitted power, as in the example of FIG. 6, the local feedback control can minimize the reflected power, in the example of FIG. 8, which is an entirely equivalent process.

In transceiver module 40C, to allow room for the reflected photodiode m_PD2 68, tunable filter 66A may be tilted slightly. Small tilts of normal incidence optical filters do not significantly impact the transmission properties of filter 66A. However, a small tilt (e.g., 10% relative to vertical) can cause enough change of angle of the reflected beam (2× the angle of incidence) and allow room for the placement of photodiode m_PD2 68. Therefore, the example illustrated in FIG. 8 provides simplification and cost reduction, as compared to FIG. 6, where both the examples illustrated in FIGS. 6 and 8 use a tunable receiver filter to lock and clean up the laser output of network interface devices 28, but the example in FIG. 8 relies on reflection of optical power, which allows for minimal components in the transmit path.

FIG. 9 is a block diagram illustrating another example of a transceiver module of a network interface device. FIG. 9 illustrates transceiver module 40D, which is another example of transceiver module 38 of FIG. 3. In FIG. 9, components with the same reference numerals as those in FIG. 4, 6, or 8 are like components and are not described further.

For example, in FIG. 9, transceiver module 40D may not require a second photo-diode. In this case, the transceiver is further simplified with the elimination of the second m_PD2 68. The concept behind this approach is that with the high reflectivity of tunable filter 66B when laser 42 is not tuned to the transmit passband, a large portion of light will reflect back into laser 42. In general, lasers do not function optimally when there are unintended reflections back into the laser cavity. It is likely that the original back facet m_PD1 70 (or m_PD1 44 in the other examples) will be able to detect changes in the laser power due to the back refection and controller 32 may utilize m_PD1 70 for tuning purposes as well as the classic monitoring functions. For instance, as with the example in FIG. 8, controller 32 may adjust the wavelength as which tunable laser 42 is ouputting optical signals until the current ouputted by m_PD1 70 is approximately minimized because, at that wavelength of tunable laser 42, there is very little reflection and most of the signal is passing through filter 66B. When most of the optical signal is passing through filter 66B, tunable laser 42 is tuned to the defined wavelength.

In some cases, it is likely for tunable filter 66B to have a small angle of incidence off of normal incidence to eliminate back reflections even when laser 42 is properly tuned to the filter passband. No filter is perfectly transparent so a non-normal incidence is needed. Even in this case, the example illustrated in FIG. 9 may still be used as the angle may be chosen to be sufficient to avoid back reflection effects when tuned, but not when mis-tuned. It may also be possible that the back reflection beam can be angled enough to avoid the laser cavity but to pass through the laser die to the m_PD1 70. For example, m_PD1 70 may be relatively large or sized such it still receives reflected optical signals even if tehre is a small angle of incidence in tunable filter 66B. In this way, the back-facet diode of the m_PD1 70 may perform “double duty.” For example, the current outputted by m_PD1 70 may be used for power control and to ensure that tunable laser 42 is tuned to the right optical wavelength. In some examples, it may be possible for there to be two back-facet diodes within the laser package, where one of the back-facet diodes functions as a monitor diode for the laser driver, and the other back-facet diode functions as a monitor diode for laser tuning

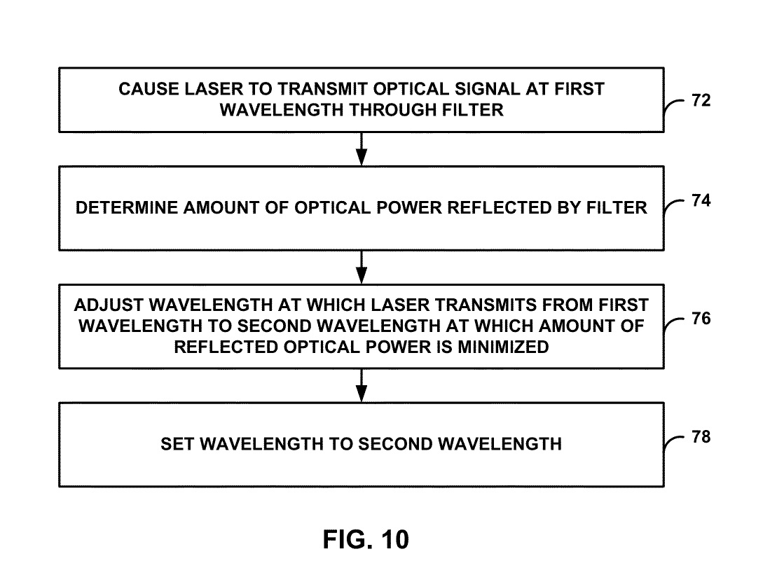

FIG. 10 is a flowchart illustrating an example method of operation in accordance with techniques described in this disclosure. For example, a controller (e.g., controller 32) may cause a laser (e.g., tunable laser 42) to transmit an optical signal at a first wavelength through a filter (e.g., tunable filter 66A or 66B) (72). The controller may determine an amount of optical power of the optical signal reflected by the filter (74). For example, the controller may determine the amount of optical power reflected by the filter based on a current outputted by a photo-diode.

In some examples, the photo-diode is the back facet photo-diode within a package that houses the laser (e.g., m_PD1 70). In some examples, the filter is positioned at an angle, as illustrated with tunable filter 66A in FIG. 8. In these examples, the photo-diode is a photo-diode other than a back facet photo-diode within a package that houses the laser (e.g., m_PD2 68). The photo-diode may also be positioned based on the angle of the filter (e.g., two times the angle of incidence of the filter). Moreover, as illustrated in FIG. 7, the filter (e.g., tunable filter 60, 66A, or 66B) may be a tunable filter with a downstream wavelength passband and an upstream wavelength passband.

The controller may adjust the wavelength at which the laser transmits the optical signal from the first wavelength to a second wavelength at which the amount of optical power reflected by the filter is reduced (e.g., approximately minimized) (76). The controller may set the wavelength of the laser to the second wavelength at the conclusion of adjusting the wavelength from the first wavelength to the second wavelength (78).

The controller may adjust the wavelength at which the laser transmits the optical signal from the first wavelength to the second wavelength at which the current outputted by the photo-diode is minimized (e.g., m_PD1 70 of FIG. 9 or m_PD2 68 of FIG. 8). In some examples, the controller may adjust the wavelength at which the laser transmits the optical signal from the first wavelength to the second wavelength at which the amount of optical power reflected by the filter is minimized without receiving feedback from an optical line terminal (OLT) (e.g., OLT 12). In some examples, the controller may adjust the wavelength at which the laser transmits the optical signal from the first wavelength to the second wavelength at which the amount of optical power reflected by the filter is minimized without coupling a tap filter to an upstream output of the filter (e.g., without coupling tap filter 62 as illustrated in FIG. 6).

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors (e.g., processor 44 or controller 32), such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” or “controller” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
causing a laser to transmit an optical signal at a first wavelength through a filter;
determining an amount of optical power of the optical signal reflected by the filter; and
adjusting a wavelength at which the laser transmits the optical signal from the first wavelength to a second wavelength at which the amount of optical power reflected by the filter is approximately minimized.

2. The method of claim 1,
wherein determining the amount of optical power reflected by the filter comprises determining the amount of optical power reflected by the filter based on a current outputted by a photo-diode, and
wherein adjusting the wavelength at which the laser transmits the optical signal from the first wavelength to the second wavelength at which the amount of optical power reflected by the filter is approximately minimized comprises adjusting the wavelength at which the laser transmits the optical signal from the first wavelength to the second wavelength at which the current outputted by the photo-diode is approximately minimized.

3. The method of claim 2, wherein the photo-diode comprises a back facet photo-diode within a package that houses the laser.

4. The method of claim 2, wherein the filter is positioned at an angle, and wherein the photo-diode comprises a photo-diode other than a back facet photo-diode within a package that houses the laser and the photo-diode is positioned relative to the angle of the filter to receive the reflected optical signal from the filter.

5. The method of claim 1, wherein the filter comprises a tunable filter with a downstream wavelength passband and an upstream wavelength passband.

6. The method of claim 1, wherein adjusting the wavelength at which the laser transmits the optical signal from the first wavelength to the second wavelength at which the amount of optical power reflected by the filter is approximately minimized comprises adjusting the wavelength at which the laser transmits the optical signal from the first wavelength to the second wavelength at which the amount of optical power reflected by the filter is approximately minimized without receiving feedback from an optical line terminal (OLT).

7. The method of claim 1, wherein adjusting the wavelength at which the laser transmits the optical signal from the first wavelength to the second wavelength at which the amount of optical power reflected by the filter is approximately minimized comprises adjusting the wavelength at which the laser transmits the optical signal from the first wavelength to the second wavelength at which the amount of optical power reflected by the filter is approximately minimized without using a tap filter that reflects a portion of an upstream output of the filter.

8. A network interface device comprising:
a laser;
a filter; and
a controller configured to:
cause the laser to transmit an optical signal at a first wavelength through the filter;
determine an amount of optical power of the optical signal reflected by the filter; and
adjust a wavelength at which the laser transmits the optical signal from the first wavelength to a second wavelength at which the amount of optical power reflected by the filter is approximately minimized.

9. The network interface device of claim 8, further comprising:
a photo-diode,
wherein to determine the amount of optical power reflected by the filter, the controller is configured to determine the amount of optical power reflected by the filter based on a current outputted by the photo-diode, and
wherein to adjust the wavelength at which the laser transmits the optical signal from the first wavelength to the second wavelength at which the amount of optical power reflected by the filter is approximately minimized, the controller is configured to adjust the wavelength at which the laser transmits the optical signal from the first wavelength to the second wavelength at which the current outputted by the photo-diode is approximately minimized.

10. The network interface device of claim 9, wherein the photo-diode comprises a back facet photo-diode within a package that houses the laser.

11. The network interface device of claim 9, further comprising:
a back facet photo-diode within a package that houses the laser,
wherein the filter is positioned at an angle, wherein the photo-diode comprises a photo-diode other than the back facet photo-diode, and wherein the photo-diode is positioned relative to the angle of the filter to receive the reflected optical signal from the filter.

12. The network interface device of claim 8, wherein the filter comprises a tunable filter with a downstream wavelength passband and an upstream wavelength passband.

13. The network interface device of claim 8, wherein to adjust the wavelength at which the laser transmits the optical signal from the first wavelength to the second wavelength at which the amount of optical power reflected by the filter is approximately minimized, the controller is configured to adjust the wavelength at which the laser transmits the optical signal from the first wavelength to the second wavelength at which the amount of optical power reflected by the filter is approximately minimized without receiving feedback from an optical line terminal (OLT).

14. The network interface device of claim 8, wherein to adjust the wavelength at which the laser transmits the optical signal from the first wavelength to the second wavelength at which the amount of optical power reflected by the filter is approximately minimized, the controller is configured to adjust the wavelength at which the laser transmits the optical signal from the first wavelength to the second wavelength at which the amount of optical power reflected by the filter is approximately minimized without using a tap filter that reflects a portion of an upstream output of the filter.

15. A network interface device comprising:
means for causing a laser to transmit an optical signal at a first wavelength through a filter;
means for determining an amount of optical power of the optical signal reflected by the filter; and
means for adjusting a wavelength at which the laser transmits the optical signal from the first wavelength to a second wavelength at which the amount of optical power reflected by the filter is approximately minimized.

16. The network interface device of claim 15,
wherein the means for determining the amount of optical power reflected by the filter comprises means for determining the amount of optical power reflected by the filter based on a current outputted by a photo-diode, and
wherein the means for adjusting the wavelength at which the laser transmits the optical signal from the first wavelength to the second wavelength at which the amount of optical power reflected by the filter is approximately minimized comprises means for adjusting the wavelength at which the laser transmits the optical signal from the first wavelength to the second wavelength at which the current outputted by the photo-diode is approximately minimized.

17. The network interface device of claim 15, wherein the means for adjusting the wavelength at which the laser transmits the optical signal from the first wavelength to the second wavelength at which the amount of optical power reflected by the filter is approximately minimized comprises means for adjusting the wavelength at which the laser transmits the optical signal from the first wavelength to the second wavelength at which the amount of optical power reflected by the filter is approximately minimized without receiving feedback from an optical line terminal (OLT).

18. The network interface device of claim 15, wherein the means for adjusting the wavelength at which the laser transmits the optical signal from the first wavelength to the second wavelength at which the amount of optical power reflected by the filter is approximately minimized comprises means for adjusting the wavelength at which the laser transmits the optical signal from the first wavelength to the second wavelength at which the amount of optical power reflected by the filter is approximately minimized without using a tap filter that reflects a portion of an upstream output of the filter.

19. A computer-readable storage medium having instructions stored thereon that when executed cause one or more processors to:
cause a laser to transmit an optical signal at a first wavelength through a filter;
determine an amount of optical power of the optical signal reflected by the filter; and
adjust a wavelength at which the laser transmits the optical signal from the first wavelength to a second wavelength at which the amount of optical power reflected by the filter is approximately minimized.

20. The computer-readable storage medium of claim 19,
wherein the instructions that cause the one or more processors to determine the amount of optical power reflected by the filter comprise instructions that cause the one or more processors to determine the amount of optical power reflected by the filter based on a current outputted by a photo-diode, and
wherein the instructions that cause the one or more processors to adjust the wavelength at which the laser transmits the optical signal from the first wavelength to the second wavelength at which the amount of optical power reflected by the filter is approximately minimized comprise instructions that cause the one or more processors to adjust the wavelength at which the laser transmits the optical signal from the first wavelength to the second wavelength at which the current outputted by the photo-diode is approximately minimized.

21. A system comprising:
an optical line terminal (OLT); and
a network interface device comprising:
a laser;
a filter; and
a controller configured to:
cause the laser to transmit an optical signal at a first wavelength through the filter to the OLT;
determine an amount of optical power of the optical signal reflected by the filter; and
adjust a wavelength at which the laser transmits the optical signal from the first wavelength to a second wavelength at which the amount of optical power reflected by the filter is approximately minimized without receiving feedback from the OLT.
